(19) United States
(12) Patent Application Publication
(10) Pub. No.: US 2012/0026331 A1
(43) Pub. Date: Feb. 2, 2012

(54) Seat Belt Usage Indication

(76) Inventors: James E. Winner, JR., Sharon, PA (US); Donna C. Winner, Hollywood Beach, FL (US)

(21) Appl. No.: 13/143,305

(22) PCT Filed: Jan. 5, 2010
(86) PCT No.: PCT/US10/20128

§ 371 Date: Oct. 11, 2011

Related U.S. Application Data
(60) Provisional application No. 61/142,547, filed on Jan. 5, 2009.

(51) Int. Cl. H04N 7/18; B60Q 1/00

(52) U.S. Cl. 348/148; 340/425.5; 348/E07.085

(57) ABSTRACT

The invention provides notification externally of a vehicle that the vehicle's seatbelts are not being used or are being used improperly. In a first embodiment, an external lamp is connected to a seat belt interlock. If a seat belt is being used properly during vehicle operations, the external lamp will not be illuminated, but if the seat belt is not being used or is being used improperly during vehicle operations, the external lamp will be illuminated. In a second embodiment, a transmitter generates a signal if a seat belt is not being used or is being used improperly during vehicle operations. The signal is transmitted to a receiver that is in electrical communication with a camera in the immediate vicinity. Upon receipt of such a signal, the camera and a video recorder will be activated and a visual image or a sequence of visual images of the vehicle will be taken and recorded. In a third embodiment, a transmitter generates a signal if a seat belt is not being used or is being used improperly during vehicle operations. A law enforcement vehicle such as a police car includes a receiver adapted to receive the signal and an annunciator. When the receiver receives a signal, the annunicator will be activated and a law enforcement officer in the police car will be notified that a vehicle is being operated nearby in violation of the seatbelt-usage laws. Consequently, the law enforcement officer will be able to locate the vehicle and take appropriate enforcement action.

### REFERENCE TO PROVISIONAL APPLICATION

Applicant hereby incorporates by reference and claims priority from U.S. provisional application Ser. No. 61/142,547, filed Jan. 5, 2009 by James E. Winner, Jr. entitled “Seatbelt Usage Indication.”

### BACKGROUND OF THE INVENTION

1. Field of the Invention

The invention relates to vehicle seat belt usage and, more particularly, to a method and apparatus for indicating to a non-occupant of a vehicle whether or not a vehicle seat belt is being used.

2. Description of the Prior Art

Seatbelts have been widely used in the United States and other countries for many years. Typically, seatbelts are used in automobiles, trucks, vans, and other highway vehicles as well in industrial and agricultural equipment such as tractors, combines, cranes, backhoes, and the like. As used herein, the terms “vehicle” or “vehicles” means any passenger-carrying form of locomotion, whether intended for highway use or not, and whether intended for personal, agricultural, industrial, or any other use.

Seatbelts, when used properly, generally are believed to be effective in preventing injury or death in the event of a vehicle crash, rollover, or other sudden vehicle movement. The belief in seatbelt effectiveness is such that many governmental jurisdictions have mandated that seatbelts be provided as standard equipment in all vehicles, and that the seatbelts so provided must be used by a driver and any passengers during vehicle operation.

Unfortunately, many individuals refuse to wear seatbelts on a consistent basis. While interlocks have been provided to alert the driver and passengers that a seatbelt is not being used, it is possible to defeat the interlocks by fastening the seatbelts and sitting on the seatbelts. Other techniques can be used to defeat the interlocks, such as inserting a disconnected belt buckle in a seatbelt lock.

Various approaches have been taken in an attempt to address the foregoing concerns. In U.S. Pat. No. 4,849,733, an external light is provided for a vehicle. The external light is colored blue or amber in order to distinguish it from the vehicle's operating lights. A switch is activated when the seatbelt is buckled and the external light is illuminated. Accordingly, an outside observer such as a law enforcement officer will be able to determine visually when the seatbelt is being used.

Another approach is disclosed in U.S. Pat. No. 7,005,976. In the '976 patent, various sensors such as an acceleration sensor, a buckle interlock, and other devices are used to determine not only that the seat buckle is engaged, but also that the belt is properly positioned on the user. The '976 patent discloses a variety of control/warning features such as a speed governor, an ignition/transmission lock, and an external warning lamp that are operated by an interlock mechanism. If the interlock mechanism senses that the seat belt is not fastened or is not being used properly, the lamp will notify non-occupants of that fact.

Other techniques are disclosed in U.S. Pat. Nos. 7,271,712; 7,446,652; and 6,942,248. In the '712 patent, if a seat belt if not fastened or is not being used properly, a transmitter transmits an electromagnetic signal to an exterior device that provides exterior notification of that fact. In the '652 patent, if a seat belt is not fastened or is not being used properly, an electromagnetic signal is transmitted to a monitor who can contact the driver concerning proper seat belt usage. In the '248 patent, a signal is generated based on such factors as whether a child seat is in use, the orientation of the child seat, and so forth. A receiver receives the signal and generates a different signal which can be used for various purposes such as informing third parties of the occupancy status of the vehicle. In one instance, a signal will be sent to assistance personnel in the event of an accident.

For convenience, all of the foregoing patents will be referred to herein as “the Seatbelt patents.” Applicant incorporates the disclosures of each of the Seatbelt patents by reference herein.

Despite the approaches taken by the Seatbelt patents, certain concerns remain. More particularly, there remains a need for law enforcement authorities to determine whenever a vehicle is being operated without seatbelts being used or where the seatbelts are being used improperly. As used herein, reference to seatbelts not being used or being used improperly includes not only seatbelts intended to be used by drivers and passengers, but also to seatbelts intended to be used to restrain child seats and/or children.

### SUMMARY OF THE INVENTION

In response to the foregoing concerns, the present invention provides a new and improved method and apparatus especially adapted to provide notification externally of a vehicle that the vehicle's seatbelts are not being used or are being used improperly. In a first embodiment of the invention, a vehicle includes one or multiple external lamps that are connected to a seat belt interlock. If the seat belt is being used properly during vehicle operations, the external lamp(s) will not be illuminated. If the seat belt is not being used during vehicle operations, or if it is not being used properly during such operations, the external lamp(s) will be illuminated. The system therefore provides a positive indication to an observer that a seat belt is not being used or is being used improperly.

In a second embodiment of the invention, a vehicle includes a transmitter that generates a signal if a seat belt is not being used during vehicle operations, or if it is not being used properly during such operations. The signal is transmitted to a receiver included as part of an external video recorder, e.g., a red light camera, radar-activated speed camera, or other specialty camera, that may be in the immediate vicinity. Upon receipt of such a signal, the video recorder will be activated and a visual image or a sequence of visual images of the vehicle will be taken and recorded. A vehicle can include a transmitter and one or multiple external lamps that are both activated when a seat belt is not being used or is being used improperly during vehicle operations. If both the external lamps are illuminated and a signal is generated by the transmitter when a seat belt is not being used or is being used improperly during vehicle operations, the image(s) recorded by the recorder as a response to the signal will show the vehicle with external lamp(s) illuminated, indicating that a seat belt is not being used or is being used improperly. If desired or required by the law, the camera or cameras of the video recorder can be set up so that the recorded image(s) show the vehicle's license plate, either the front license plate or the rear license plate or both, and a portion of the vehicle's interior where the driver and any front seat passengers are located. If necessary, ambient lighting and/or external flash or strobes connected to the video recorder can be used to illuminate the exterior and/or interior of the vehicle. Since the vehicle and/or the driver and any front seat passengers and/or the illuminated external lamp(s) are captured in the image(s), the image(s) will constitute visual evidence that the seat belts were not being used or were being used improperly. If desired, the signal generated by the transmitter can include information such as vehicle identification, transmitter identification, detailed seat occupancy and seat belt usage information, date and time, location of the vehicle, etc., and the information can be recorded by the recorder in conjunction with the recorded image(s) as supplemental or independent evidence that the seat belts were not being used or were being used improperly.

In a third embodiment of the invention, a vehicle includes a transmitter that generates a signal if a seat belt is not being used during vehicle operations, or if it is not being used properly during such operations. A law enforcement vehicle such as a police car includes a receiver adapted to receive the signal when the police car is in the vicinity of the vehicle. The police car includes an annunicator that is activated upon receipt of such a signal. The annunciator will notify the law enforcement officer driving the police car that a vehicle is being operated nearby in violation of the seatbelt-usage laws. Accordingly, the officer will be able to locate the vehicle and take appropriate enforcement action. A vehicle can include both the transmitter and one or multiple external lamps that are connected to a seat belt interlock. If a seat belt is not being used during vehicle operations, or if it is not being used properly during such operations, the illuminated external lamp(s) can help officer locate and identify the vehicle and take appropriate enforcement action.

The foregoing and other features and advantages of the invention will be apparent from a review of the following description of the invention, taken together with the attached drawings.

### BRIEF DESCRIPTION OF THE DRAWINGS

FIG. 1 is a schematic view of a first embodiment of the invention;

FIG. 2 is a schematic view of a second embodiment of the invention; and

FIG. 3 is a schematic view of a third embodiment of the invention.

FIG. 4 is a schematic view of a logic diagram that illustrates one possible implementation of the seat belt usage indication system of the invention.

### DESCRIPTION OF THE PREFERRED EMBODIMENT

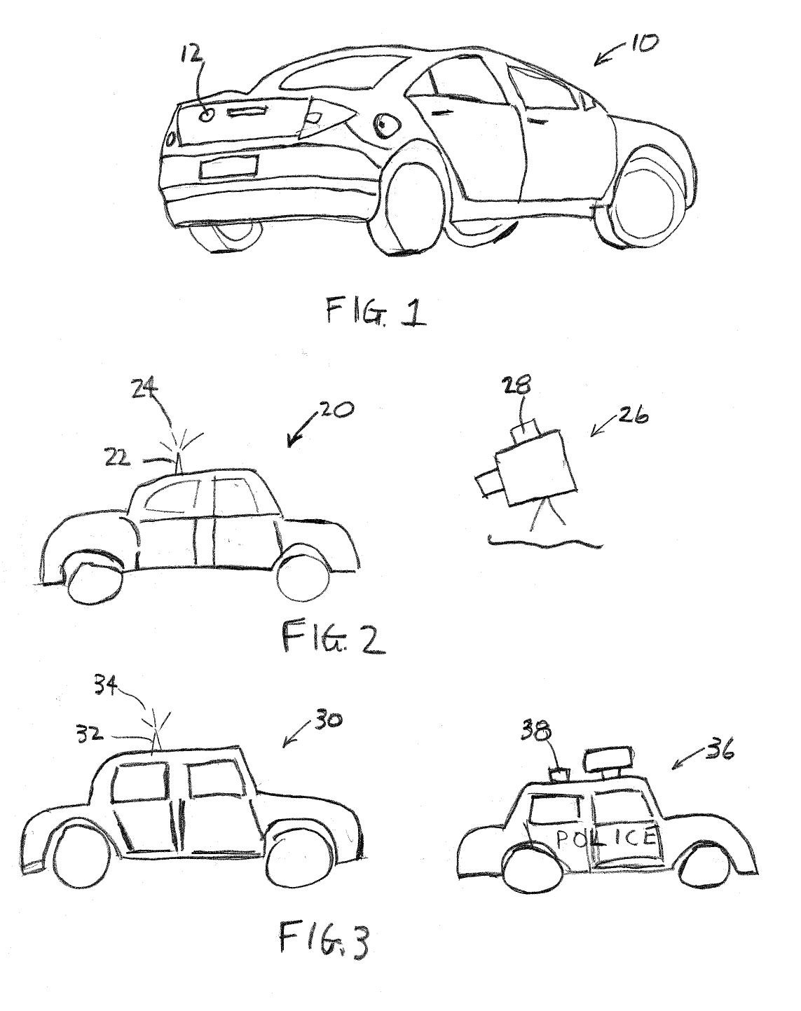

Referring to FIG. 1, a first embodiment of the invention is shown schematically. A vehicle 10 includes an external lamp 12 that is connected to a seat belt interlock. Preferably the lamp 12 is of a distinctive color such as blue or green that can be distinguished readily from conventional vehicle operating lights. Also, it is preferred that the lamp 12 be extremely reliable; for example, a light-emitting diode (LED) of suitable brightness may be used, if desired. Although not shown in FIG. 1, multiple external lamps that are connected to the seat belt interlock may be deployed, if desired. The external lamps can be located in the front and/or the rear and/or other places of a vehicle, if desired.

If the seat belt is being used properly during vehicle operations, the external lamp 12 will not be illuminated. On the other hand, if the seat belt is not being used during vehicle operations, or if it is not being used properly during such operations, the external lamp 12 will be illuminated. The system therefore provides a positive indication to an observer such as a law enforcement officer that a seat belt if not being used or is being used improperly.

Referring to FIG. 2, a second embodiment of the invention is shown schematically. A vehicle 20 includes a transmitter 22 that generates a signal 24 if a seat belt is not being used during vehicle operations, or is not being used properly during such operations. The signal 24 may be any type, such as infrared, laser, radio frequency, etc., that can be transmitted at least relatively short distances such as several hundred feet or more. Preferably, the signal 24 is an electromagnetic signal that is not line-of-sight. The signal 24 may be of any form, such as a single pulse, multiple pulses, continuous waves, etc. The signal 24 may encode information such as vehicle identification, transmitter identification, detailed seat occupancy and seat belt usage information, date and time, location of the vehicle, etc., if desired. Although not explicitly shown in FIG. 2, a vehicle can include both the transmitter that generates a signal and one or multiple external lamps that are illuminated when a seat belt is not being used or is being used improperly during vehicle operations.

A video recorder 26 in the nature of a red light camera, radar-activated speed camera, or other specialty camera includes a receiver 28. The receiver 28 is adapted to receive the signal 24 that is being transmitted by a vehicle 20 that may be in the immediate vicinity. Upon receipt of such the signal 24, the video recorder 26 will be activated and an image or a sequence of images of the vehicle 20 will be created. Preferably, the image(s) will be digitally recorded. The recorded image(s) may be stored locally in a storage device in or attached to the video recorder 26, or transmitted to a remote back office data center either manually or through a wired or wireless network. If the vehicle includes external lamp(s) and the external lamp(s) are illuminated in conjunction with the signal being generated as a response to a seat belt not being used or being used improperly during vehicle operations, the recorded image(s) will show the vehicle with external lamp(s) illuminated indicating that a seatbelt is not being used or is being used improperly. If desired or required by the law, the camera or cameras can be set up so that the recorded image(s) show the vehicle's license plate, either the front license plate or the rear license plate or both, and a portion of the vehicle's interior where the driver and any front seat passengers are located. Since the vehicle and/or the driver and any front seat passengers and/or the illuminated external lamp(s) are captured in the image, the image will constitute visual evidence that the seat belts were not being used or were being used improperly. If the signal 24 includes information such as vehicle identification, transmitter identification, detailed seat occupancy and seat belt usage information, date and time, location of the vehicle, etc., the information can be recorded in conjunction with the recorded image(s) as supplemental or independent evidence that the seat belts were not being used or were being used improperly.

Referring to FIG. 3, a third embodiment of the invention is shown schematically. In this embodiment, a vehicle 30 includes a transmitter 32 that generates a signal 34 if a seat belt is not being used during vehicle operations, or is not being used properly during such operations. The signal 34 preferably is an electromagnetic signal (such as a radio signal). If it is economically feasible, the transmitter 32 can be a transponder that receives an interrogating signal and that transmits a reply signal upon receipt of an interrogating signal.

A law enforcement vehicle such as a police car is indicated by the reference numeral 36. The police car 36 includes a receiver 38 that is adapted to receive the signal 34 that is being transmitted by a vehicle 30 that may be in the vicinity. Upon receipt of the signal 34, an annunciator such as an aural or visual alarm will be activated so that the officer driving the police car 36 will be notified that the vehicle 30 is being operated nearby in violation of the seatbelt-usage laws. Accordingly, the officer will be able to locate the vehicle 30 and take appropriate enforcement action. A vehicle can include both the transmitter and one or multiple external lamps that are connected to a seat belt interlock. If the vehicle includes external lamp(s) and the external lamp(s) are illuminated in conjunction with the signal being generated as a response to a seat belt not being used or being used improperly during vehicle operations, the illuminated external lamp(s) will help the officer locate and identify the vehicle.

If the transmitter 32 is a transponder and the police car 36 has a corresponding transmitter (not shown) that sends a suitable interrogating signal, the task of locating the vehicle 30 will be quite easy. This is because the reply signal generated by the transmitter 32 will provide specific information to the officer concerning the location of the vehicle 30.

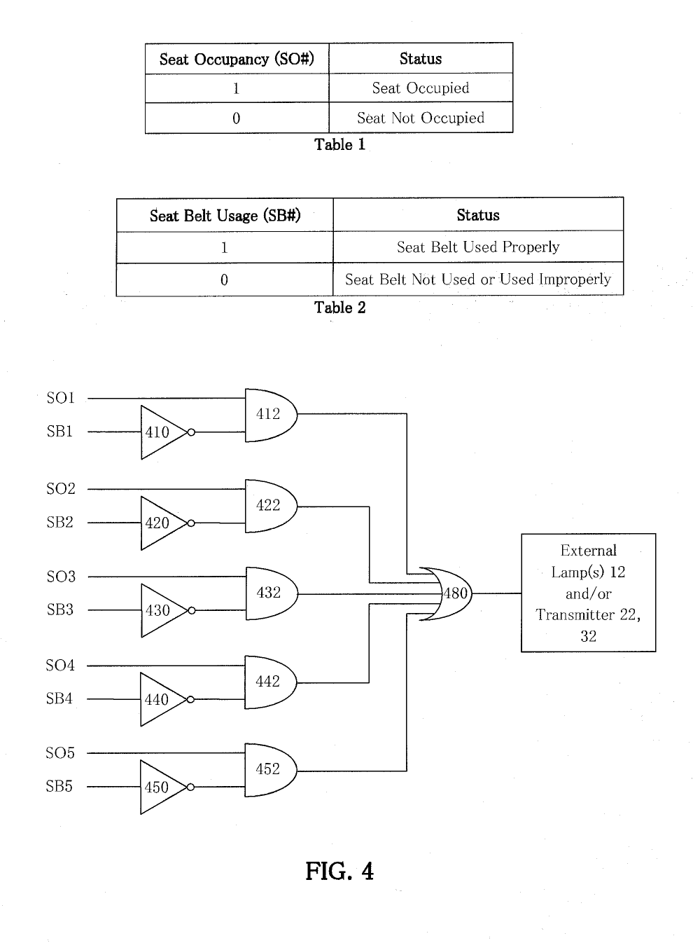

Referring to FIG. 4, a logic diagram that illustrates one possible implementation of the seat belt usage indication system is shown schematically. Table 1 in FIG. 4 shows the logic outputs of a seat occupancy sensor SO#, with “1” indicating that the seat # is occupied and “0” indicating that the seat # is not occupied. Table 2 in FIG. 4 show the logic outputs of a seat belt usage sensor SB#, with “1” indicating that the seat belt for seat # is being used properly and “0” indicating that the seat belt for seat # is not being used or is being used improperly. SO1, SO2, SO3, SO4, and SO5 are the logic outputs of the seat occupancy sensors for seat 1, 2, 3, 4, and 5 respectively. SB1, SB2, SB3, SB4, and SB5 are the logic outputs of the seat belt usage sensors for seat 1, 2, 3, 4, and 5 respectively. 410, 420, 430, 440, and 450 are logic NOT gates, whose logic outputs are inverse of the inputs. 412, 422, 432, 442, and 452 are logic AND gates, whose logic outputs are “1” if and only if both of their inputs are “1”. 480 is a five-input logic OR gate, whose output is “1” if and only if any one of its inputs is “1”. The output of the OR gate 480 controls the external lamp(s) 12 and/or the transmitter 22, 32 described in the three embodiments of the invention. If the output of the OR gate 480 is “1”, the external lamp(s) 12 will be illuminated and/or the transmitter 22, 32, will generate a signal, indicating that at least one seat is occupied and the seat belt is not being used or is being used improperly. If the output of the OR gate 480 is “0”, the external lamp(s) will not be illuminated and the transmitter will be inactive, indicating that the seat belts for all occupied seats are being used properly.

FIG. 4 shows a possible logic diagram of the seat belt usage indication system for five seats as an example. However, the logic diagram can be easily modified by people skilled at this art to indicate the seat belt usage for any number of desired seats in a vehicle. The seat occupancy sensors and seat belt usage sensors could be switches, analog devices, digital devices, or other means whose outputs can be converted to and represented by the logic states as displayed in Table 1 and Table 2 of FIG. 4. Any or all of the outputs of seat occupancy sensors and seat belt usage sensors could be represented in logic inverse of the states shown in Table 1 and Table 2 of FIG. 4; In that case, corresponding changes can be made to the logic diagram, e.g. by adding inverters (logic NOT gates) between the corresponding sensor outputs and the logic AND gate inputs, to achieve the same cause-effect result. Although the mechanism is illustrated using logic NOT, AND, and OR gates as shown in FIG. 4, persons skilled in the art can choose to represent and express the underlying logic in equivalent forms using other logic gates. In addition, although the mechanism is illustrated using logic gates, persons skilled in the art can choose to use analog circuits, digital circuits, hybrid analog/digital circuits, or processors and computer programs to implement the mechanism.

In each of the described embodiments, steps can be taken to prevent the system from being overridden by the vehicle operator. For instance, an interlock such as disclosed in the Seatbelt patents can be installed that will disable the vehicle 10 if the vehicle operator should disable or remove the lamp 12. Similarly, interlocks can be used to prevent vehicle operation if the transmitters 22, 32 are disabled or removed.

Although the invention has been described in its preferred form with a certain degree of particularity, it will be understood that the present disclosure of the preferred embodiments has been made only by way of example and that various changes may be resorted to without departing from the true spirit and scope of the invention as hereinafter claimed.

What is claimed is:

1. Apparatus for indicating whether seatbelts included as part of a vehicle are not being used or are being used improperly during vehicle operations, comprising:
sensing means for sensing whether the seatbelts are not being used or are being used improperly during vehicle operations;
indication means for indicating externally of the vehicle whenever the seatbelts are not being used or are being used improperly during vehicle operations; and
activation means for activating the indication means whenever the seatbelts are not being used or are being used improperly during vehicle operations.

2. The apparatus of claim 1, wherein the sensing means is a seat belt interlock, the indication means is an external lamp carried by the vehicle that is electrically connected to the seat belt interlock, and the activation means is circuitry for controlling illumination of the external lamp, the circuitry causing the external vehicle lamp to not be illuminated if the seat belt is being used properly during vehicle operations, and the circuitry causing the external vehicle lamp to be illuminated if the seat belt is not being used or is not being used properly during such operations.

3. The apparatus of claim 2, wherein the external lamp is of a distinctive color different than that of conventional vehicle operating lights.

4. The apparatus of claim 2, wherein the external lamp is a light-emitting diode of suitable brightness.

5. The apparatus of claim 2, wherein multiple external lamps are provided for different parts of the vehicle.

6. The apparatus of claim 2, further comprising means for preventing operation of the vehicle if any of the sensing means, the indication means, or the activation means is disabled or removed.

7. The apparatus of claim 1, wherein the indication means and the activation means include:
a transmitter carried by the vehicle that generates a signal if a seat belt is not being used or is being used improperly;
a camera positioned such that it will capture images of a passing vehicle;
a video recorder electrically connected to the camera;
a receiver for receiving the signal generated by the transmitter, the receiver being in electrical communication with the camera;
circuitry for activating the camera upon receipt of a signal by the receiver; and
circuitry for activating the video recorder when the camera has been activated, whereby a visual image or a sequence of visual images of the vehicle will be taken and recorded.

8. The apparatus of claim 7, wherein the camera is a red light camera, radar-activated speed camera, or other specialty camera.

9. The apparatus of claim 7, further comprising an external lamp on the vehicle that is activated when a seat belt is not being used or is being used improperly during vehicle operations, the lamp being located on the vehicle so that images taken of the vehicle by the camera will show that the external lamp is illuminated.

10. The apparatus of claim 7, further comprising a license plate on the vehicle, the license plate being located on the vehicle so that images taken of the vehicle by the camera will show the license plate.

11. The apparatus of claim 7, further comprising an ambient lamp connected to the video recorder and directed toward passing vehicles, the ambient lamp being illuminated upon activation of the video recorder so as to illuminate the exterior and/or interior of a passing vehicle.

12. The apparatus of claim 7, wherein the signal generated by the transmitter includes information concerning vehicle identification, transmitter identification, seat occupancy, seat belt usage information, date and time of signal generation, and/or location of the vehicle and/or camera.

13. The apparatus of claim 12, wherein the information concerning vehicle identification, transmitter identification, seat occupancy, seat belt usage information, date and time of signal generation, and/or location of the vehicle and/or camera is recorded by the video recorder.

14. The apparatus of claim 1, wherein the indication means and the activation means include:
a transmitter carried by the vehicle that generates a signal if a seat belt is not being used or is being used improperly;
a receiver for receiving the signal generated by the transmitter, the receiver being located in a law enforcement vehicle;
an annunciator in the law enforcement vehicle, the annunciator being in electrical communication with the receiver; and
the annunciator being activated upon receipt of a signal by the receiver, whereby a law enforcement officer in the law enforcement vehicle will be notified that a vehicle is being operated nearby in violation of the seatbelt-usage laws.

15. The apparatus of claim 14, further comprising:
a seat belt interlock;
an external lamp carried by the vehicle that is electrically connected to the seat belt interlock; and
circuitry for controlling illumination of the external lamp, the circuitry causing the external lamp to not be illuminated if the seat belt is being used properly during vehicle operations, and the circuitry causing the external lamp to be illuminated if the seat belt is not being used or is not being used properly during such operations.

16. The apparatus of claim 14, further comprising a transmitter in the law enforcement vehicle, wherein:
the transmitter carried by the vehicle is a transponder;
the transmitter in the law enforcement vehicle is capable of sending an interrogating signal to the transponder carried by the vehicle; and
the receiver in the law enforcement vehicle is capable of receiving a reply signal from the transponder, the receiver in the law enforcement vehicle providing information to the law enforcement officer concerning the location of the vehicle.

17. A method for indicating whether seatbelts included as part of a vehicle are not being used or are being used improperly during vehicle operations, comprising the steps of:
sensing whether the seatbelts are not being used or are being used improperly during vehicle operations;
providing indication means for indicating externally of the vehicle whenever the seatbelts are not being used or are being used improperly during vehicle operations; and
activating the indication means whenever the seatbelts are not being used or are being used improperly during vehicle operations.

18. The method of claim 17, wherein the step of sensing is accomplished by providing a seat belt interlock, the step of providing indication means is accomplished by providing an external lamp carried by the vehicle that is electrically connected to the seat belt interlock, and the step of activating the indication means is accomplished by providing circuitry for controlling illumination of the external lamp, the circuitry causing the external vehicle lamp to not be illuminated if the seat belt is being used properly during vehicle operations, and the circuitry causing the external vehicle lamp to be illuminated if the seat belt is not being used or is not being used properly during such operations.

19. The method of claim 17, wherein the steps of providing indication means and activating the indication means are accomplished by providing:
a transmitter carried by the vehicle that generates a signal if a seat belt is not being used or is being used improperly;
a camera positioned such that it will capture images of a passing vehicle;
a video recorder electrically connected to the camera;
a receiver for receiving the signal generated by the transmitter, the receiver being in electrical communication with the camera;
circuitry for activating the camera upon receipt of a signal by the receiver; and
circuitry for activating the video recorder when the camera has been activated, whereby a visual image or a sequence of visual images of the vehicle will be taken and recorded.

20. The method of claim 17, wherein the steps of providing indication means and activating the indication means are accomplished by providing:
a transmitter carried by the vehicle that generates a signal if a seat belt is not being used or is being used improperly;
a receiver for receiving the signal generated by the transmitter, the receiver being located in a law enforcement vehicle;
an annunciator in the law enforcement vehicle, the annunciator being in electrical communication with the receiver; and
the annunciator being activated upon receipt of a signal by the receiver, whereby a law enforcement officer in the law enforcement vehicle will be notified that a vehicle is being operated nearby in violation of the seatbelt-usage laws.
